(19) United States
(12) Patent Application Publication
(10) Pub. No.: US 2008/0047985 A1
(43) Pub. Date: Feb. 28, 2008

(54) TIRE COVER FOR A SPARE TIRE CARRIER

(76) Inventor: Anthony J. Newbill, Wickenburg, AZ (US)

Correspondence Address: SCHMEISER OLSEN & WATTS, 18 E UNIVERSITY DRIVE, SUITE # 101, MESA, AZ, 85201, US

(21) Appl. No.: 11/928,326

(22) Filed: Oct. 30, 2007

Related U.S. Application Data
(63) Continuation-in-part of application No. 11/863,180, filed on Sep. 27, 2007.
(63) Continuation-in-part of application No. 11/863,178, filed on Sep. 27, 2007.
(63) Continuation-in-part of application No. 11/688,781, filed on Mar. 20, 2007.
(63) Continuation-in-part of application No. 10/784,654, filed on Feb. 23, 2004, now abandoned.

(51) Int. Cl. B62D 43/00

(52) U.S. Cl. 224/42.2

(57) ABSTRACT

A vehicle includes a tire carrier support structure coupled with a vehicle frame. A tire carrier assembly is carried by the tire carrier support structure, wherein the tire carrier assembly is repeatably movable between raised and lowered positions. A tire cover assembly is carried by the tire carrier support structure. The tire cover assembly can be moved so that it extends upwardly when the tire carrier assembly is in the lowered position.

### CROSS-REFERENCE TO RELATED APPLICATIONS

This application is a continuation-in-part of U.S. patent application Ser. Nos. 11/863,180 and 11/863,178, which were both filed on Sep. 27, 2007, and claim priority to U.S. patent application Ser. Nos. 10/784,654 and 11/688,781 filed on Feb. 23, 2004 and Mar. 20, 2007, respectively, the contents of all of which are incorporated herein by reference.

### BACKGROUND OF THE INVENTION

1. Field of the Invention

This invention relates generally to vehicles which carry a spare tire.

2. Description of the Related Art

Most vehicles have a spare tire, which can be carried by it at many different locations. For example, some spare tires are carried on the undercarriage of the vehicle, but most of them are carried in the vehicle trunk. Sport utility vehicles, however, typically do not have a trunk so the spare tire must be carried elsewhere. Further, tires for sport utility vehicles are generally large in size and weight, which makes it inconvenient to position them on and remove them from the undercarriage and the vehicle's interior.

Hence, sport utility vehicles often include a spare tire carrier assembly for holding the spare tire. Examples of these spare tire carrier assemblies can be found in U.S. Pat. Nos. 5,104,015, 5,186,371 and 5,333,766. However, their use often requires the operator to lift the spare tire, which is strenuous if the spare tire is heavy and bulky. Further, the difficulty in lifting the spare tire is increased if the vehicle is located on an uneven surface.

### BRIEF SUMMARY OF THE INVENTION

The present invention includes a vehicle having a tire carrier support structure coupled with a vehicle frame. A tire carrier assembly is carried by the tire carrier support structure, wherein the tire carrier assembly is repeatably movable between raised and lowered positions. A tire cover assembly is carried by the tire carrier support structure. The tire cover assembly can be moved so that it extends upwardly when the tire carrier assembly is in the lowered position. In some embodiments, the tire cover assembly includes one or more vehicle accessories, which are electrically connected to an electrical system of the vehicle with a wiring harness.

In another embodiment, a vehicle includes a vehicle frame with D-ring hinge and latch brackets coupled with it. A tire carrier assembly is carried by the D-ring hinge bracket and a tire cover assembly is carried by the tire carrier support structure.

The present invention also includes a vehicle having a vehicle frame with opposed longitudinal frame members, and a tire carrier support structure coupled with the longitudinal frame members so it extends between them. D-ring hinge and latch brackets are coupled with the vehicle frame through the tire carrier support structure. A tire carrier assembly is coupled with the hinge bracket.

The present invention includes a vehicle having a vehicle frame with opposing longitudinal frame members. Opposing frame extensions are coupled with corresponding longitudinal frame members. D-ring hinge and latch brackets are coupled with corresponding frame extensions and a tire carrier assembly is coupled with the D-ring hinge bracket.

These and other features, aspects, and advantages of the present invention will become better understood with reference to the following drawings and description.

### BRIEF DESCRIPTION OF THE DRAWINGS

FIG. 1a is a perspective rear view of a vehicle for carrying a tire carrier support structure, in accordance with the invention.

FIG. 1b is an exploded perspective view of the tire carrier support structure of FIG. 1a carrying a tire carrier assembly and a tire cover assembly, in accordance with the invention.

FIG. 1c is a perspective view of the tire carrier assembly of FIG. 1b and a tire cover support member having different orientations.

FIG. 1d is a side view of the tire carrier assembly of FIG. 1b and a tire cover support member having different orientations.

FIG. 1e is a side view of the tire carrier assembly of FIG. 1b in a lowered position and carrying a tire cover support member.

FIG. 2a is a perspective view of a vehicle carrying a hitch mounted tire carrier support structure, in accordance with the invention.

FIG. 2b is an exploded perspective view of the hitch mounted tire carrier support structure of FIG. 2a carrying a tire carrier assembly and tire cover assembly, in accordance with the invention.

FIG. 3a is a perspective view of a vehicle carrying a D-ring latch assembly and D-ring hinge assembly, in accordance with the invention.

FIG. 3b is an exploded perspective view of the D-ring latch assembly and D-ring hinge assembly of FIG. 3a carrying a tire carrier assembly and tire cover assembly, in accordance with the invention.

FIGS. 4a and 4b are perspective views of a tire carrier assembly, in accordance with the invention, and a tire cover assembly.

FIG. 5a is an exploded perspective view of a tire carrier assembly and tire cover assembly, in accordance with the invention.

FIG. 5b is an exploded perspective view of a tire carrier assembly and tire cover assembly, in accordance with the invention.

FIG. 6a is an exploded perspective view of a vehicle frame which carries a tire carrier support structure and a vehicle bumper, in accordance with the invention.

FIG. 6b is a perspective view of a vehicle frame which carries a tire carrier support structure and vehicle bumper, in accordance with the invention.

FIG. 7a is a side view of a vehicle frame having a frame extension, in accordance with the invention.

FIG. 7b is a side view of a vehicle frame having a frame extension, in accordance with the invention.

FIG. 8a is a side view of a tire cover, which carries a vehicle accessory.

FIG. 8b is a perspective view of the tire cover of FIG. 1b carrying the vehicle accessory of FIG. 8a.

FIG. 8c is a perspective view of the tire cover of FIG. 4a carrying the vehicle accessory of FIG. 8a.

FIG. 8d is a side view of vehicle accessories of FIG. 8a and a tire carrier assembly.

### DETAILED DESCRIPTION OF THE INVENTION

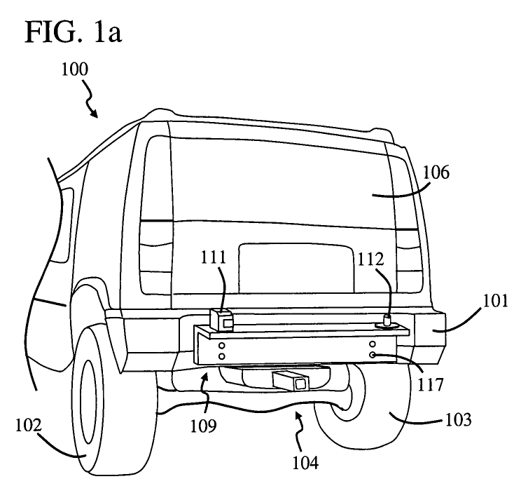

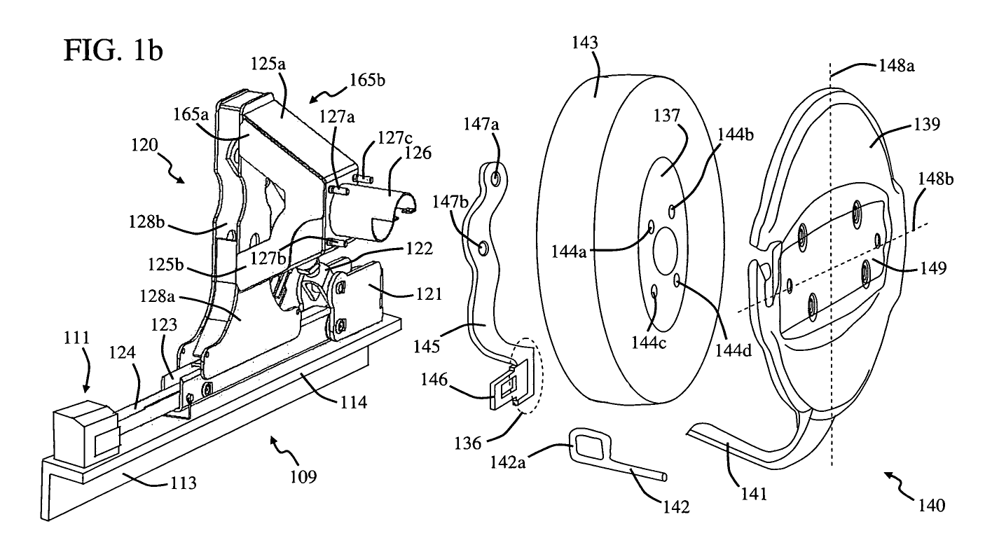

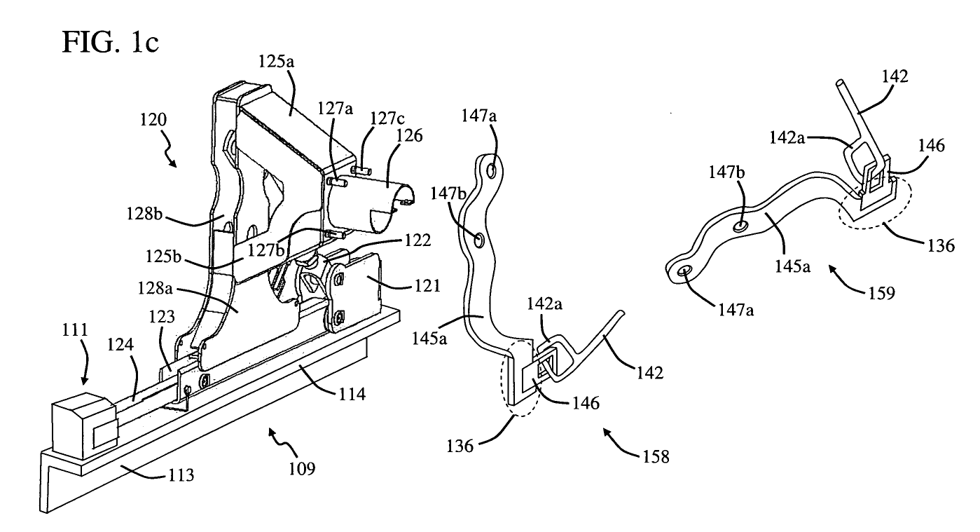

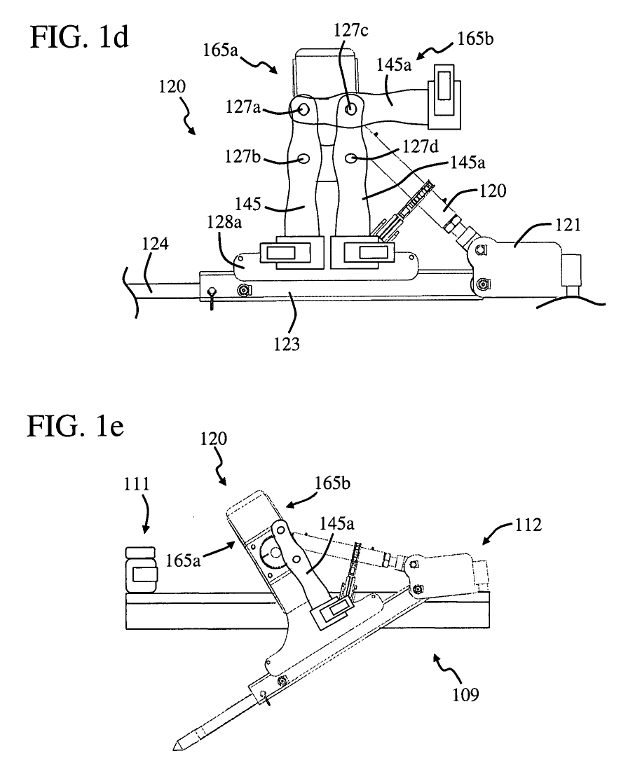

FIG. 1a is a perspective view of a vehicle 100 carrying a tire carrier support structure 109, in accordance with the invention. FIG. 1b is an exploded perspective view of tire carrier support structure 109 carrying a tire carrier assembly 120 and a tire cover assembly 140, in accordance with the invention. More information regarding tire carrier support structure 109 and tire carrier assembly 120 can be found in co-pending patent application Ser. No. 11/688,781, filed on Mar. 20, 2007 by the same inventor. More information regarding tire cover assembly 140 can be found in U.S. Pat. No. 6,003,922, the contents of which are incorporated herein by reference. More information regarding a tire carrier assembly that is repeatably movable between stowed and deployed positions, as well as raised and lowered positions, can be found in U.S. Pat. No. 6,659,318, the contents of which are incorporated herein by reference.

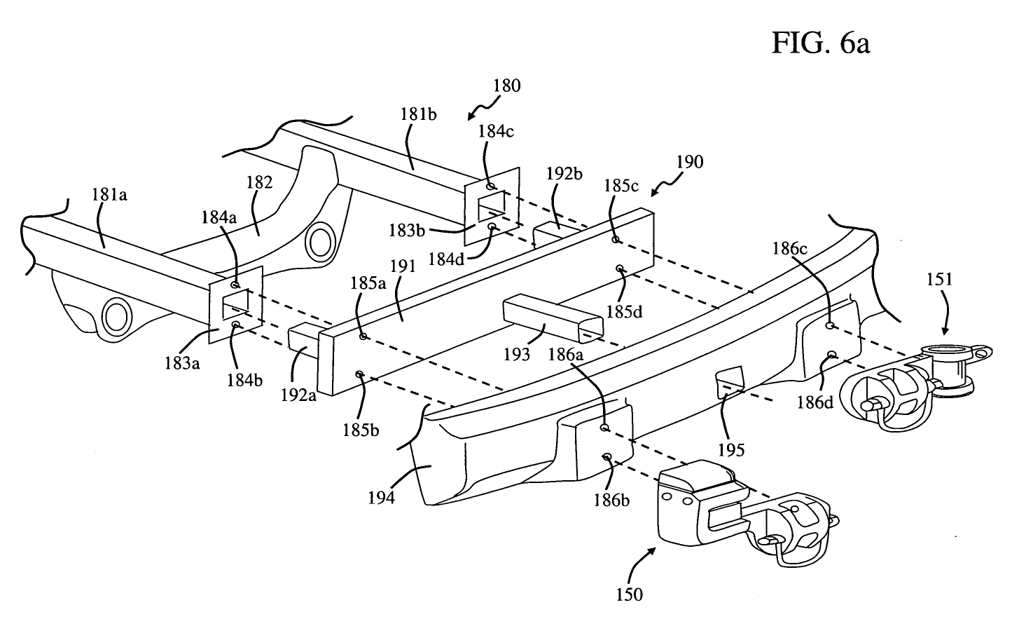

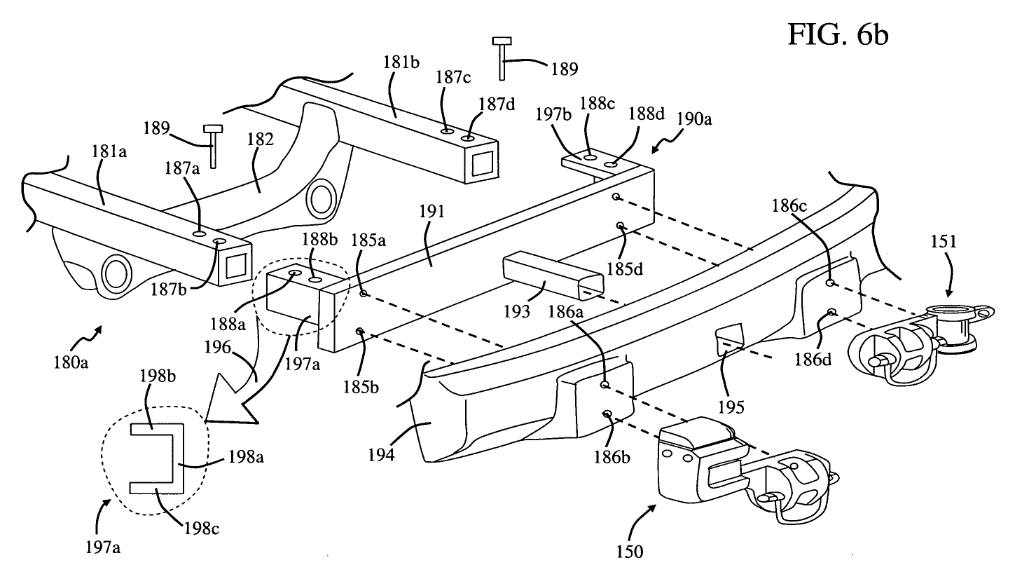

Vehicle 100 can be of many different types, but here it is embodied as a Hummer, which is the civilian version of the military Hum Vee vehicle. In this embodiment, vehicle 100 includes a vehicle frame which carries a vehicle bumper 101 and trailer hitch 104 proximate to rear wheels 102 and 103. Further, vehicle 100 carries tire carrier support structure 109 proximate to a rear 106 of vehicle 100. In this embodiment, tire carrier support structure 109 and vehicle bumper 101 are coupled with the vehicle frame with elongate members 117. Elongate members 117 can be of many different types, such as bolts. It should be noted that the vehicle frame provides support for the components included with vehicle 100, such as its engine, front and rear wheels, suspension and body. The vehicle frame also provides support for tire carrier support structure 109 and vehicle bumper 101. A few examples of vehicle frames are discussed in more detail below with FIGS. 6a and 6b. More information regarding vehicle frames can be found in U.S. Pat. No. 6,702,347, the contents of which are incorporated herein by reference.

In this embodiment, tire carrier support structure 109 includes a base member 114 and a sidewall member 113 coupled together (FIG. 1b), wherein elongate members 117 extend through sidewall member 113. Tire carrier support structure 109 includes a rotary latch 111 and tire carrier mounting post 112, which are both carried by base member 114. It should be noted that tire carrier support structure 109 is stronger and more rugged than vehicle bumper 101, so support structure 109 is capable of carrying more weight.

Tire carrier assembly 120 can be of many different types. In this embodiment, tire carrier assembly 120 includes a mounting bracket 121 having a lower connection point for connecting to an end of a swing arm 123 and an upper connection point for connecting to an end of an actuator 122. Examples of actuators include hydraulic and pneumatic cylinder actuators. One particular type of actuator is manufactured by Thompson Saginaw and is known as Model No. PPA23. More information regarding actuators can be found in U.S. Pat. No. 6,659,318.

In another embodiment, actuator 120 includes a threaded sleeve and a threaded shaft operatively coupled together. The threaded shaft and threaded sleeve are operatively coupled together so they can be moved relative to each other in response to moving a hand grip. More information about actuators that include a threaded shaft and sleeve can be found in U.S. Pat. No. 6,659,318.

Mounting bracket 121 also includes a post sleeve (not shown) extending through it, wherein the post sleeve is sized and shaped to receive tire carrier mounting post 112 so that mounting bracket 121 can rotate about an axis of rotation of the post sleeve. Mounting bracket 121 can rotate so that tire carrier assembly 120 is repeatably movable between stowed and deployed positions.

In this embodiment, tire carrier assembly 120 includes opposed arm plates 128a and 128b which are coupled with swing arm 123 and extend upwardly therefrom. Opposed arm plates 128a and 128b are also coupled with an opposed end of actuator 122. Actuator 122 can be actuated to raise and lower opposed arm plates 128a and 128b so that tire carrier assembly 120 is repeatably movable between raised and lowered positions.

In this embodiment, tire carrier assembly 120 includes a pivot arm 124 which is pivotably coupled with an opposed end of swing arm 123, and is repeatably movable between extended and retracted positions. Pivot arm 124 is moved to the extended position by moving it away from opposed arm plates 128a and 128b and pivot arm 124 is moved to the retracted position by moving it towards opposed arm plates 128a and 128b. In this way, tire carrier assembly 120 is repeatably movable between extended and retracted positions.

In the extended position, pivot arm 124 is repeatably movable between latched and unlatched conditions with rotary latch 111. In the latched condition, tire carrier assembly 120 is in the stowed position and, in the unlatched condition, tire carrier assembly is in the deployed position.

Tire carrier assembly 120 includes opposed hub unit arms 125a and 125b which are coupled with arm plate 128a. Tire carrier assembly 120 includes a hub unit 126 coupled with opposed hub unit arms 125a and 125b. Hub unit 126 is for holding a spare tire 143, wherein spare tire 143 includes a tire rim 137 with openings 144a, 144b, 144c and 144d extending therethrough. In this embodiment, hub unit 126 includes bolts 127a, 127b, 127c and 127d (not shown) positioned to be received by openings 144a, 144b, 144c and 144d, respectively, of tire rim 137.

In this embodiment, tire cover assembly 140 includes a tire cover 139 coupled with a tire cover arm 141. Tire cover 139 includes a license plate holder 149 which is rectangular in shape and extends lengthwise along a reference line 148b. A reference line 148a extends transversely to the length of license plate holder 149 and perpendicular to reference line 148a. It should be noted that license plate holder 149 can be oriented in many different directions relative to reference lines 148a and 148b, but its orientation generally depends on the orientation of tire cover 139 relative to spare tire 143. In general, it is desirable to have license plate holder 149 oriented so that a license plate attached thereto is right-side up when tire cover 139 covers spare tire 143.

In this embodiment, tire cover assembly 140 includes a connector 142 having a loop portion 142a. Tire cover assembly 140 includes a tire carrier support member 145 with a loop portion 146 and openings 147a and 147b. Loop portions 146 and 142a are coupled together and connector 142 is coupled with tire cover arm 141 so that tire cover 139 is coupled with tire cover support member 145. Tire cover 139 is repeatably movable between positions covering and uncovering spare tire 143 by rotating connector 142 relative to tire cover support member 145. Connector 142 can be rotated relative to tire cover support member 145 by rotating loop portion 142a relative to loop portion 146.

In accordance with the invention, tire cover assembly 140 is coupled with vehicle 100 through tire carrier support structure 109. Tire cover assembly 140 can be coupled with vehicle 100 through tire carrier support structure 109 in many different ways. In this embodiment, tire cover support member 140 is coupled with hub unit 126 by extending bolts 127a and 127b through openings 147a and 147b, respectively, as shown in a front side view of tire carrier assembly in FIG. 1d. It should be noted that, in this embodiment, loop 146 is positioned so that when bolts 127a and 127b are received by openings 147a and 147b, respectively, loop 146 extends proximate to a side 165a of opposed hub unit arms 125a and 125b and away from a side 165b. However, in other embodiments, bolts 125c and 125d are received by openings 147a and 147b, respectively, so that tire cover support member 145 is positioned proximate to side 165b and away from side 165a. When bolts 125c and 125d are received by openings 147a and 147b, respectively, loop 146 extends towards side 165a and away from side 165b.

Tire cover assembly 140 can be coupled with hub unit 126 in many other ways. For example, as shown in FIG. 1c, tire cover support member 145 can be replaced with a tire cover support member 145a, as indicated by an indication arrow 158 in FIG. 1c. Support member 145a includes loop 146 positioned so that it extends towards side 165b (FIG. 1d) of opposed hub unit arms 125a and 125b and away from side 165b when bolts 127a and 127b are received by openings 147a and 147b, respectively.

In another embodiment, tire cover support member 145a is positioned so that bolts 127a and 127c are received by openings 147a and 147b, respectively, as indicated by an indication arrow 159 in FIG. 1c. In still another embodiment, tire cover support member 145a is positioned so that bolts 127c and 127d are received by openings 147a and 147b, respectively. It should be noted that, in general, tire cover support members 145 and 145a can be positioned relative to bolts 127a, 127b, 127c and 127d to position loop 146 at a desired location relative to tire carrier assembly 120, as shown in FIG. 1d. Further, in some embodiments, more than one tire cover support member can be carried by tire carrier assembly 120 so that the user has more options when connecting loop 142a with loop 146.

In accordance with the invention, a portion 136 of tire cover support member 145 and loop 146 is chosen so that connector 142 can be rotated so it extends towards side 165a and 165b. In this way, tire cover 139 can be moved away from spare tire 143 so it is positioned proximate to side 165a and 165b, respectively. This is useful because in some situations, tire cover 139 is removed from spare tire 143 when tire carrier assembly 120 is in the raised position and in other situations, tire cover 139 is removed from spare tire 143 when tire carrier assembly 120 is in the lowered position. When tire carrier assembly 120 is in the lowered position, it is useful to have tire cover 139 positioned proximate to side 165b so that it extends away from the ground.

As mentioned above, and in more detail in the above-referenced co-pending patent applications, tire carrier assembly 120 is repeatably movable between stowed and deployed positions, raised and lowered positions and extended and retracted positions. In accordance with the invention, tire cover assembly 140 is repeatably movable between stowed and deployed positions in response to moving tire carrier assembly 120 between the stowed and deployed positions because tire cover assembly 140 is carried by tire carrier assembly 120. Further, tire cover assembly 140 is repeatably movable between raised and lowered positions in response to moving tire carrier assembly 120 between the raised and lowered positions because tire cover assembly 140 is carried by tire carrier assembly 120. Tire carrier assembly 120 and tire cover assembly 140 are shown in the lowered position in FIG. 1e.

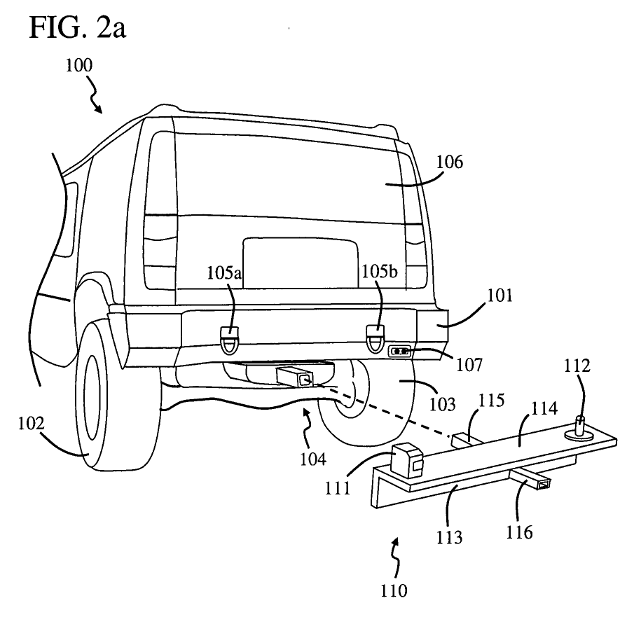

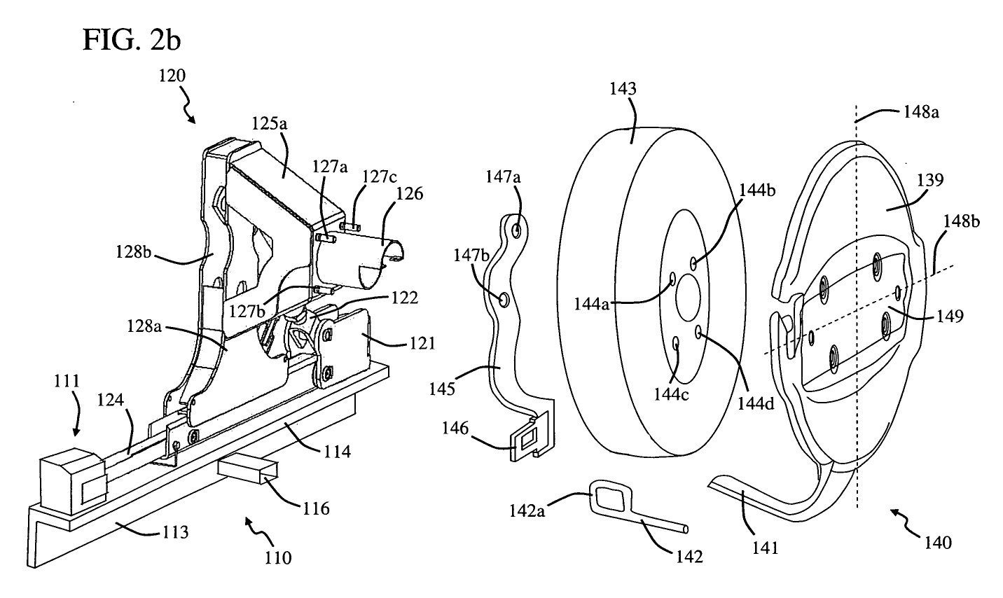

FIG. 2a is a perspective view of vehicle 100 carrying a hitch mounted tire carrier support structure 110, in accordance with the invention. FIG. 2b is an exploded perspective view of hitch mounted tire carrier support structure 110 carrying tire carrier assembly 120 and tire cover assembly 140, in accordance with the invention. More information regarding hitch mounted tire carrier support structure 109 and tire carrier assembly 120 can be found in co-pending patent application Ser. No. 11/863,180, filed on Sep. 27, 2007 by the same inventor.

In this embodiment, vehicle 100 carries tire carrier support structure 110 proximate to rear 106 of vehicle 100. Tire carrier support structure 110 includes sidewall member 113 and base member 114, wherein tire carrier support structure 110 carries rotary latch 111 and tire carrier mounting post 112 on base member 114. Tire carrier support structure 110 includes a tire carrier mounting bar 115 and trailer hitch 116 extending from opposed sides of sidewall member 113. Tire carrier mounting bar 115 is sized and shaped to be received by trailer hitch 104 so that tire carrier support structure 110 is carried by vehicle 100. D-rings 105a and 105b are used to hold vehicle bumper 101 to the frame of vehicle 100.

In accordance with the invention, tire cover assembly 140 is coupled with vehicle 100 through hitch mounted tire carrier support structure 110. Tire cover assembly 140 can be coupled with vehicle 100 through hitch mounted tire carrier support structure 110 in many different ways. In this embodiment, tire cover support member 145 is coupled with hub unit 126 by extending bolts 127a and 127b through openings 147a and 147b, respectively, as shown in a front side view of tire carrier assembly in FIG. 1d. It should be noted that tire cover support member 145 can be coupled with hub unit 126 as discussed in more detail above with FIGS. 1a-1e.

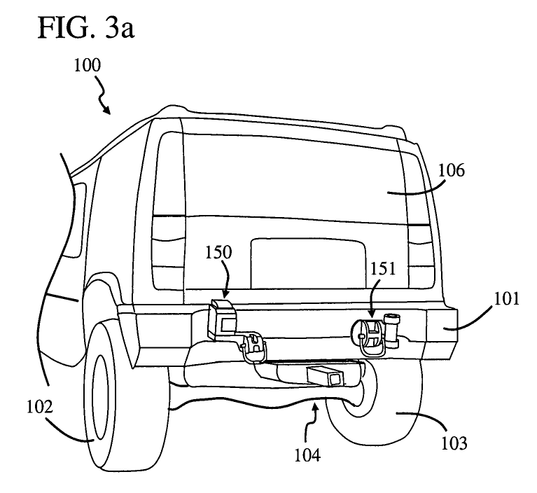

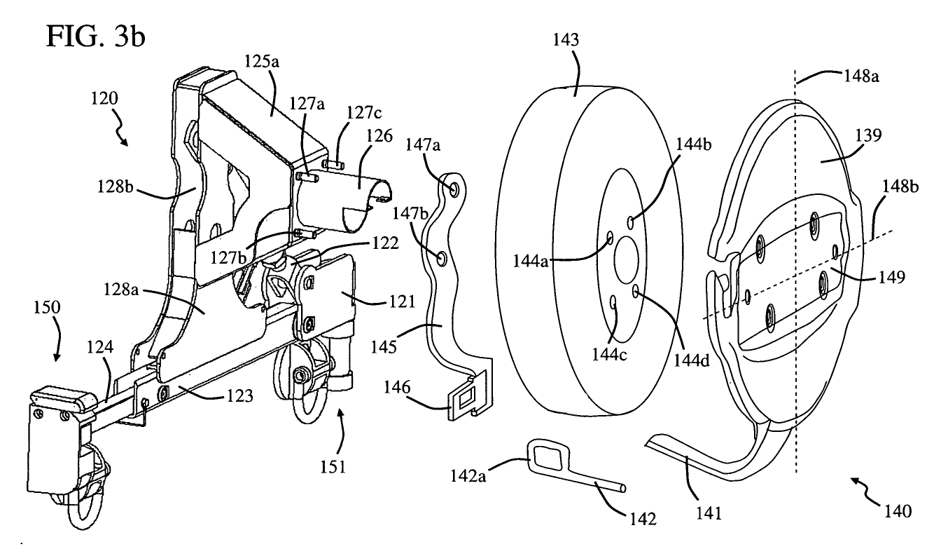

FIG. 3a is a perspective view of vehicle 100 carrying a D-ring latch assembly 150 and D-ring hinge assembly 151, in accordance with the invention. FIG. 3b is an exploded perspective view of D-ring latch assembly 150 and D-ring hinge assembly 151 carrying tire carrier assembly 120 and tire cover assembly 140, in accordance with the invention. More information regarding tire carrier assembly 120 mounted with D-ring hinge and latch brackets can be found in co-pending patent application Ser. No. 11/863,178, filed on Sep. 27, 2007 by the same inventor. More information regarding D-ring hinge and latch assemblies can be found in U.S. Design Pat. No. D505,649 and U.S. Patent Application No. 20050077327, the contents of both of which are incorporated herein by reference.

In accordance with the invention, tire cover assembly 140 is coupled with vehicle 100 through D-ring hinge assembly 151. Tire cover assembly 140 can be coupled with vehicle 100 through hitch mounted tire carrier support structure 110 in many different ways. In this embodiment, tire cover support member 140 is coupled with hub unit 126 by extending bolts 127a and 127b through openings 147a and 147b, respectively, as shown in a front side view of tire carrier assembly in FIG. 1d. It should be noted that tire cover support member can be coupled with hub unit 126 as discussed in more detail above with FIGS. 1a-1e.

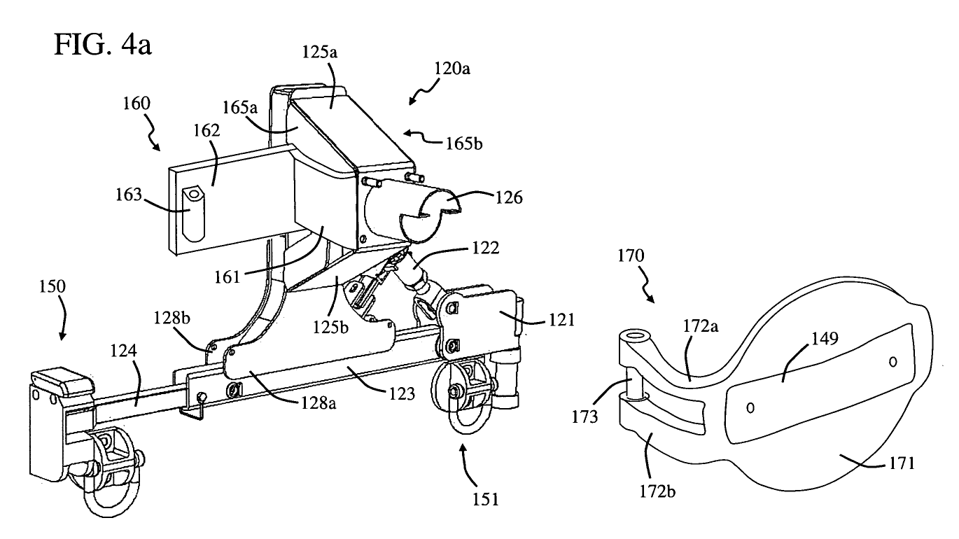

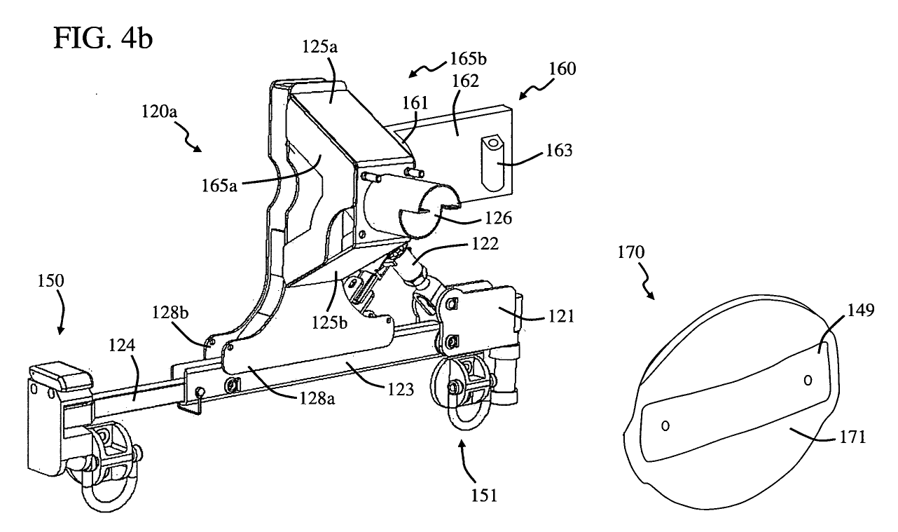

FIGS. 4a and 4b are perspective views of a tire carrier assembly 120a, in accordance with the invention, and a tire cover assembly 170. More information regarding tire cover assembly 170 can be found in U.S. Pat. Nos. 6,477,798 and 6,098,855, the contents of which are incorporated herein by reference. In this embodiment, tire carrier assembly 120a includes tire carrier assembly 120, as described in more detail above. In accordance with the invention, tire carrier assembly 120a includes a tire cover mounting assembly 160 for holding tire cover assembly 170. In this embodiment, tire cover mounting assembly 160 includes a tire cover extension arm 161 coupled with opposed hub unit arms 125a and 125b. Tire cover extension arm 161 extends from hub unit 126 towards arm plate 128a. Tire cover mounting assembly 160 includes tire cover mounting arm 162 coupled with tire cover extension arm 161. Tire cover mounting arm 162 extends outwardly from side 165a of opposed hub unit arms 125a and 125b. In FIG. 4b, tire cover mounting arm 162 extends outwardly from side 165b of opposed hub unit arms 125a and 125b. Tire cover mounting assembly 160 includes a tire cover mounting sleeve 163 carried by tire cover mounting arm 162. Tire cover mounting sleeve 163 includes an opening extending therethrough, and is for being pivotably coupled with tire cover assembly 170, as will be discussed in more detail presently.

In this embodiment, tire cover assembly 170 includes a tire cover 171 with upper and lower tire cover arms 172a and 172b. Upper and lower tire cover arms 172a and 172b are positioned away from each other so that tire cover mounting sleeve 163 can extend between them. Upper and lower tire cover arms 172a and 172b include openings extending through them which can be aligned with the opening of tire cover mounting sleeve 163. Tire cover assembly 170 includes a pivot pin 173 which can extend through the openings of upper and lower tire cover arms 172a and 172b, as well as through the opening of tire cover mounting sleeve 163. In this way, tire cover assembly 170 is pivotably mounted to tire cover mounting assembly. Tire cover 171 is repeatably movable between positions covering and uncovering a spare tire (not shown) coupled with hub unit 126 by rotating it relative to mounting sleeve 163.

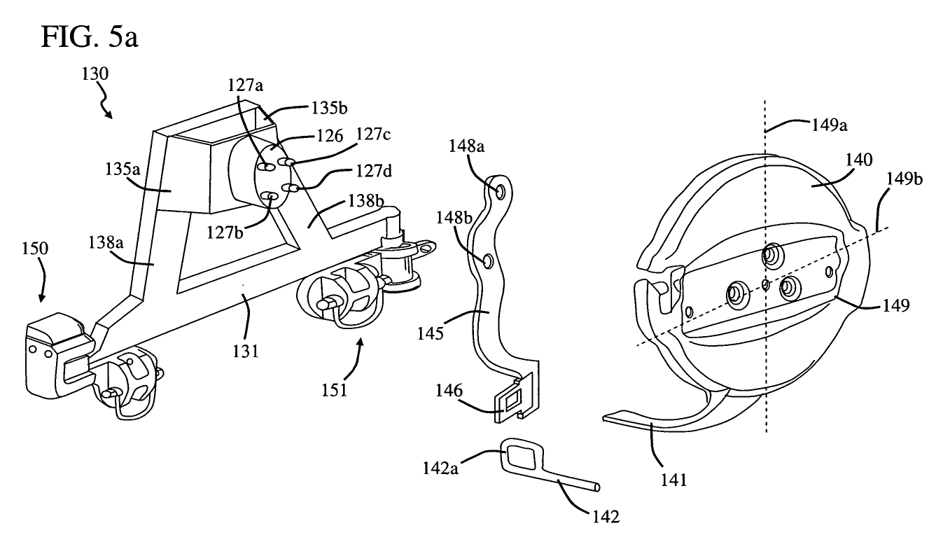

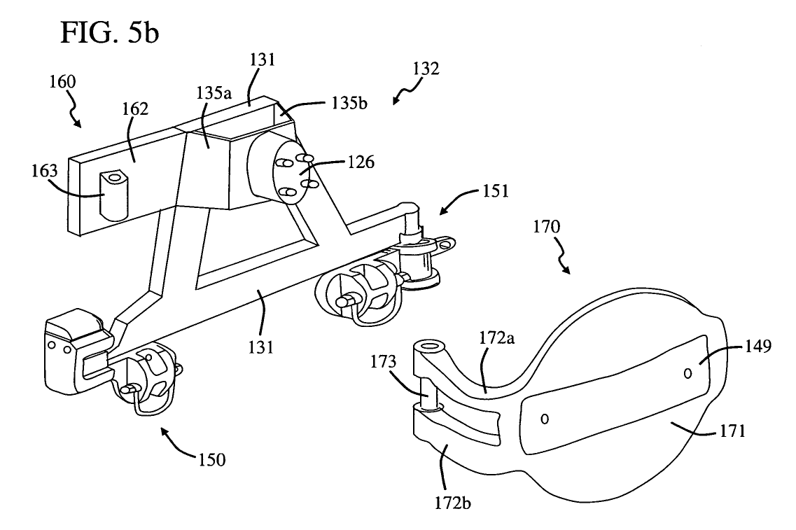

FIG. 5a is an exploded perspective view of a tire carrier assembly 130 and tire cover assembly 140, in accordance with the invention. More information regarding tire carrier assembly 130 can be found in U.S. Design Pat. No. D505,649 and U.S. Patent Application No. 20050077327. In this embodiment, tire carrier assembly 130 includes a swing arm 131 with tire carrier arms 138a and 138b extending upwardly therefrom. Swing arm 131 is rotatably mounted to D-ring hinge assembly 151 and is repeatably movable between latched and unlatched conditions with D-ring latch assembly 150. Swing arm 131 carries hub unit arms 135a and 135b and hub unit arms 135a and 135b carry hub unit 126. In this embodiment, tire carrier support member 145 can be attached to hub unit 126 as discussed in more detail above with FIGS. 1a-1e.

FIG. 5b is an exploded perspective view of a tire carrier assembly 132 and tire cover assembly 170, in accordance with the invention. In this embodiment, tire carrier assembly 132 includes tire carrier assembly 130, as described in FIG. 5a. In accordance with the invention, tire carrier assembly 132 includes tire cover mounting assembly 160, wherein tire cover mounting assembly 160 includes tire cover mounting arm 162 extending outwardly from hub unit arm 135a. Tire cover mounting assembly 160 includes tire cover mounting sleeve 163 carried by tire cover mounting arm 162. It should be noted that, in some embodiments, tire cover mounting assembly 160 can include tire cover mounting arm 162 positioned so it extends outwardly from hub unit arm 135b. It should be noted that, in FIGS. 5a and 5b, D-ring hinge and latch brackets 150 and 151 can be replaced with tire carrier support structures 109 and 110, if desired.

FIG. 6a is an exploded perspective view of a vehicle frame 180 which carries a tire carrier support structure 190 and a vehicle bumper 194, in accordance with the invention. As mentioned above, more information regarding vehicle frames can be found in U.S. Pat. No. 6,702,347. In this embodiment, vehicle frame 180 includes longitudinal frame members 181a and 181b connected together with a transverse frame member 182. Longitudinal frame members 181a and 181b extend along the length of vehicle 100 (FIG. 1a) and transverse frame member 182 extends along its width.

Longitudinal frame members 181a and 181b carry mounting plates 183a and 183b, respectively. Mounting plate 183a includes openings 184a and 184b and mounting plate 183b includes openings 184c and 184d. longitudinal frame members 181a and 181b are hollow members with each having a channel extending through them.

In this embodiment, tire carrier support structure 190 includes a sidewall 191 with mounting beams 192a and 192b coupled with it. The channels that extend through longitudinal frame members 181a and 181b are sized and shaped to receive mounting beams 192a and 192b, respectively. tire carrier support structure 190 includes a trailer hitch 193 which extends away from sidewall 191 on a side of it opposed to mounting beams 192a and 192b. tire carrier support structure 190 also includes openings 185a and 185c, 185c and 185d, which extend through sidewall 191.

In this embodiment, vehicle bumper 194 includes a trailer hitch opening sized and shaped to receive trailer hitch 193. In this way, trailer hitch 193 can be used to engage a trailer. Vehicle bumper 194 also includes openings 186a and 186c, 186c and 186d.

In accordance with the invention, tire carrier support structure 190 and vehicle bumper 194 are coupled with vehicle frame 180 using d-ring latch assembly 150 and d-ring hinge assembly 151. In this embodiment, elongate members, such as the elongate members 117 shown FIG. 1a, extend through D-ring latch assembly 150, openings 186a and 186b, openings 185a and 185b and openings 184a and 184b. Further, elongate members extend through D-ring hinge assembly 151, openings 186c, 186d, openings 185c and 185d, and openings 184c and 184d. More information regarding elongate members and their use to hold a vehicle bumper and tire carrier support structure to a vehicle frame can be found in U.S. patent application Ser. No. 11/688,781 filed on Mar. 20, 2007.

FIG. 6b is a perspective view of a vehicle frame 180a which carries a tire carrier support structure 190a and vehicle bumper 194, in accordance with the invention. In this embodiment, vehicle frame 180a includes longitudinal frame members 181a and 181b connected together with a transverse frame member 182.

In this embodiment, longitudinal frame members 181a and 181b do not carry mounting plates. Instead, longitudinal frame member 181a includes openings 187a and 187b extending through it and longitudinal frame member 181b includes openings 187c and 187d extending through it. It should be noted that longitudinal frame members 181a and 181b are shown as being hollow members in this embodiment, but they can be solid members, if desired.

In this embodiment, tire carrier support structure 190a includes sidewall 191 with c-brackets 197a and 197b coupled with it. Tire carrier support structure 190 includes trailer hitch 193 which extends away from sidewall 191 on a side of it opposed to c-brackets 197a and 197b. Tire carrier support structure 190 also includes openings 185a and 185c, 185c and 185d, which extend through sidewall 191.

As shown by an indication arrow 196, c-bracket 197a includes a base member 198a and opposed sidewall members 198b and 198c extending outwardly therefrom. Opposed sidewall members 198b and 198c include openings 188a and 188b extending through them.

In accordance with the invention, tire carrier support structure 190a and vehicle bumper 194 are coupled with vehicle frame 180a using D-ring latch assembly 150 and d-ring hinge assembly 151. In this embodiment, elongate members, such as the elongate members 117 shown FIG. 1a, extend through D-ring latch assembly 150, openings 186a and 186b, openings 185a and 185b and openings 184a and 184b. Further, elongate members extend through D-ring hinge assembly 151, openings 186c, 186d, openings 185c and 185d, and openings 184c and 184d. More information regarding elongate members and their use to hold a vehicle bumper and tire carrier support structure to a vehicle frame can be found in U.S. patent application Ser. No. 11/688,781 filed on Mar. 20, 2007.

In this embodiment, C-bracket 197a is positioned relative to longitudinal frame member 181a so that openings 188a and 188b are aligned with openings 187a and 187b, respectively. Further, C-bracket 197b is positioned relative to longitudinal frame member 181b so that openings 188c and 188d are aligned with openings 187c and 187d, respectively. Fasteners (not shown) are then extended through openings 187a-187d and corresponding openings 188a-188d to fasten vehicle frame 180a and tire carrier support structure 190a together. It should be noted that, in FIGS. 6a and 6b, D-ring hinge and latch brackets 150 and 151 can be replaced with tire carrier support structures 109 and 110, if desired.

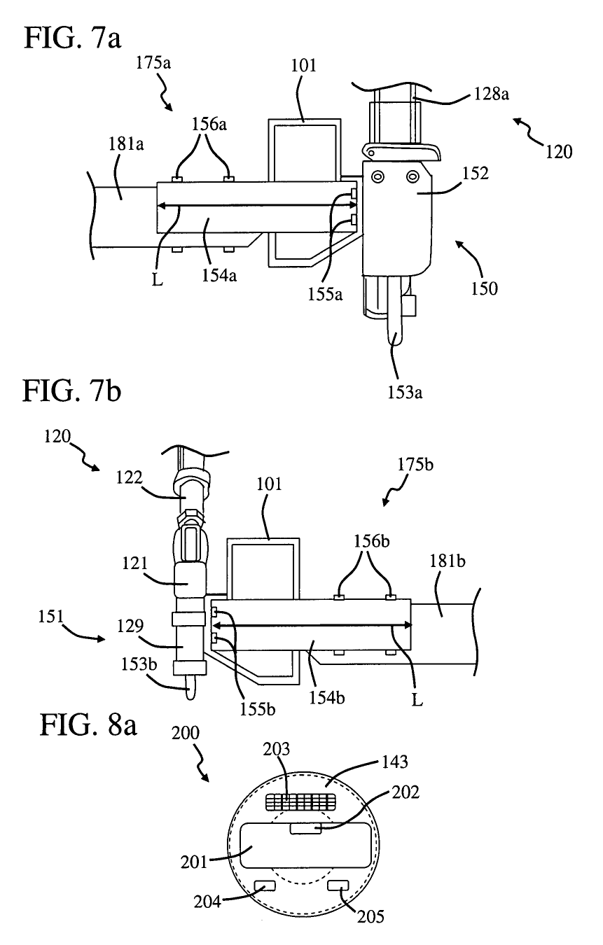

FIG. 7a is a side view of a vehicle frame 175a having a frame extension 154a, in accordance with the invention. More information regarding frame extensions can be found in U.S. Pat. No. 7,021,685 by the same inventor, the contents of which are incorporated herein by reference. In this embodiment, vehicle frame 175a includes longitudinal frame member 181a with frame extension 154a coupled with it. Frame extension 154a can be coupled with longitudinal frame member 181a in many different ways. In this embodiment, frame extension 154a is coupled with longitudinal frame member 181a with fasteners 156a, wherein fasteners 156a extend through frame extension 154a and longitudinal frame member 181a.

In this embodiment, frame extension 154a extends through vehicle bumper 101 and provides support to it. In accordance with the invention, D-ring latch assembly 150 is coupled with frame extension 154a. D-ring latch assembly 150 can be coupled with frame extension 154a in many different ways. In this embodiment, D-ring latch assembly 150 is coupled with frame extension 154a with fasteners 155a, wherein fasteners 155a extend through frame extension 154a and D-ring latch assembly 150. In this embodiment, D-ring latch assembly includes a rotary latch 152 and a D-ring 153a. Frame extension 154a has a length L which can be chosen to position tire carrier assembly 110 and vehicle bumper 101 a desired distance from longitudinal frame member 181a. This is useful so that a tire cover assembly carried by tire carrier assembly 120 can be moved between positioned covering and uncovering the spare tire without engaging rear 106 of vehicle 100.

FIG. 7b is a side view of a vehicle frame 175b having a frame extension 154b, in accordance with the invention. In this embodiment, vehicle frame 175b includes longitudinal frame member 181b with frame extension 154b coupled with it. Frame extension 154b can be coupled with longitudinal frame member 181b in many different ways. In this embodiment, frame extension 154b is coupled with longitudinal frame member 181b with fasteners 156b, wherein fasteners 156b extend through frame extension 154a and longitudinal frame member 181b.

In this embodiment, frame extension 154b extends through vehicle bumper 101 and provides support to it. In accordance with the invention, D-ring hinge assembly 151 is coupled with frame extension 154b. D-ring hinge assembly 151 can be coupled with frame extension 154b in many different ways. In this embodiment, D-ring hinge assembly 151 is coupled with frame extension 154b with fasteners 155b, wherein fasteners 155b extend through frame extension 154b and D-ring hinge assembly 151. In this embodiment, D-ring hinge assembly 151 includes a sleeve 129 and a D-ring 153b. Frame extension 154b has a length L which can be chosen to position tire carrier assembly 110 and vehicle bumper 101 a desired distance from longitudinal frame member 181b. This is useful so that a tire cover assembly carried by tire carrier assembly 120 can be moved between positioned covering and uncovering the spare tire without engaging rear 106 of vehicle 100. It should be noted that, in FIGS. 7a and 7b, D-ring hinge and latch brackets 150 and 151 can be replaced with tire carrier support structures 109 and 110, if desired.

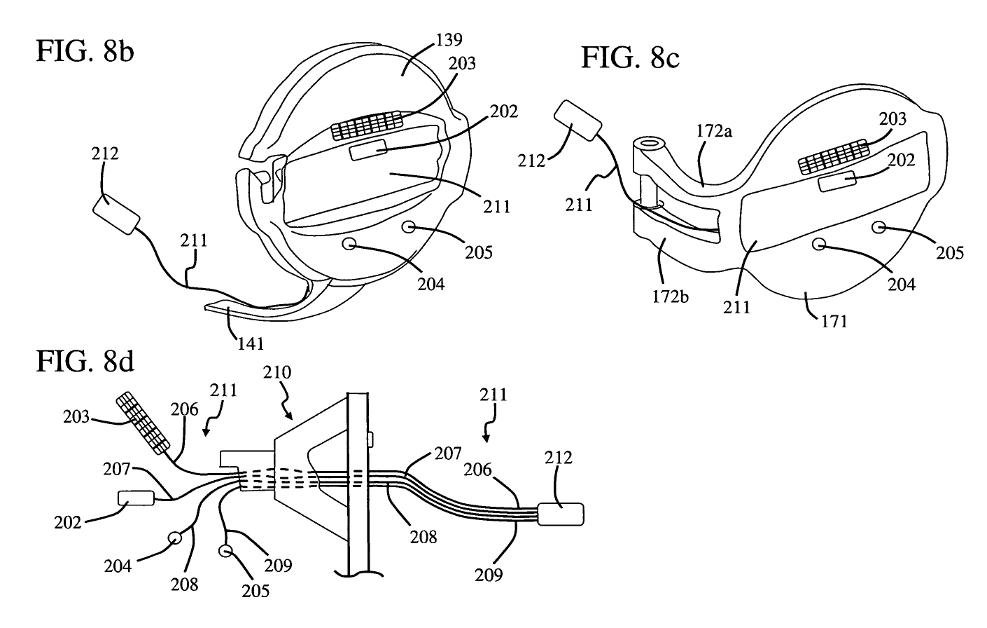

FIG. 8a is a side view of a tire cover 200, wherein tire cover 200 can replace any of the tire covers discussed in the embodiments above. For example, tire cover 200 can correspond to tire cover 139 (FIG. 8b) in tire cover assembly 140 and tire cover 171 (FIG. 8c) in tire cover assembly 170. Tire cover 200 includes one or more vehicle accessories. For example, one vehicle accessory carried by tire cover 200 is a license plate 201 and another vehicle accessory is a license plate light 202. License plate 201 is positioned so that it can be viewed when viewing the rear of vehicle 100 and license plate light 202 is positioned to illuminate license plate 201. Examples of license plate lights are disclosed in U.S. Pat. Nos. 5,150,961, 5,192,125, and 5,255,166. One type of license plate light is made by a company called Off Road Only of St. Paul, Minn. and is referred to as the LitePLATE LED.

It should be noted that tire cover 200 can carry many other types of vehicle accessories. For example, in this embodiment, tire cover 200 carries a brake light 203. Brake light 203 is positioned so that it can be viewed when viewing the rear of vehicle 100. Brake light 203 is often referred to as a “third brake light” and operates as a braking indicator. Brake light 203 can be of many different types, such as those disclosed in U.S. Pat. Nos. 4,654,757, 4,937,712, 5,550,718 and 6,404,334.

In this embodiment, tire carrier assembly 110 carries backup sensors 204 and 205. Backup sensors 204 and 205 can be of many different types, but here they are motion sensors which provide an indication of motion rearward of vehicle 100. This is useful so that an indication is provided to the driver of vehicle 100 that there is motion rearward of vehicle 100, which is useful for object avoidance. An example of a vehicle backup sensor is disclosed in U.S. Pat. No. 6,788,190. It should be noted that backup sensors 204 and/or 205 can be replaced with a video camera or used in conjunction with a video camera, wherein the video camera provides a visual indication to the driver of vehicle 100 for object avoidance. An example of a vehicle video camera is disclosed in U.S. Pat. No. 6,515,581 and U.S. Patent Application No. 20060171704.

It should also be noted that license plate light 202, brake light 203 and motions sensors 204 and 205 are generally connected to the electrical system of vehicle 100 through an electrical connector 107 (FIG. 2a). License plate light 202, brake light 203 and motions sensors 204 and 205 can be connected the electrical system of vehicle 100 in many different ways, one of which will be discussed in more detail presently.

FIG. 8d is a side view of vehicle accessories and a tire carrier assembly 210. It should be noted that tire carrier assembly can correspond to tire carrier assemblies 120, 120a, 130 and 132, which are discussed in more detail above. In this embodiment, license plate light 202 is connected to a cable 207, brake light 203 is connected to a cable 206, and motions sensors 204 and 205 are connected to cables 208 and 209, respectively. Cables 206, 207, 208 and 209 allow the flow of signals, such as power and data signals, between the vehicle electrical system and corresponding vehicle accessory. In this embodiment, cables 206, 207, 208 and 209 extend through tire carrier assembly 210. Cables 206, 207, 208 and 209 are connected to a connector 212. Connector 212 and cables 206, 207, 208 and 209 form a wiring harness 211. Connector 212 can be connected to connector 107 (FIG. 2a) which is connected to the electrical system of vehicle 100. In this way, power and data signals can flow between the electrical system of vehicle 100 and the vehicle accessories carried by tire carrier assembly 110.

It should be noted that wiring harness 211 can extend from tire covers 139 and 171 in many different ways. For example, wiring harness 211 can extend along tire cover arm 141 of tire cover 139, as shown in FIG. 8b. Wiring harness 211 can extend along tire cover arm 172a or 172b of tire cover 171, as shown in FIG. 8c. It should also be noted that wiring harness is typically chosen to be long enough so that the vehicle accessories can operated when the tire carrier assembly is in the stowed and deployed positions, as well as the raised and lowered positions.

The embodiments of the invention described herein are exemplary and numerous modifications, variations and rearrangements can be readily envisioned to achieve substantially equivalent results, all of which are intended to be embraced within the spirit and scope of the invention.

1. A vehicle, comprising:
a vehicle frame;
a tire carrier support structure coupled with the vehicle frame;
a tire carrier assembly carried by the tire carrier support structure, the tire carrier assembly being repeatably movable between raised and lowered positions; and
a tire cover assembly carried by the tire carrier support structure.

2. The vehicle of claim 1, wherein the tire cover assembly includes a tire cover support member coupled with a hub unit of the tire carrier assembly.

3. The vehicle of claim 1, wherein the tire cover assembly is repeatably movable between positions covering an uncovering a spare tire carried by the tire carrier assembly.

4. The vehicle of claim 3, wherein the tire cover assembly extends upwardly when the tire carrier assembly is in the lowered position.

5. The vehicle of claim 3, wherein the tire cover assembly extends upwardly over an actuator included in the tire carrier assembly when the tire carrier assembly is in the lowered position.

6. The vehicle of claim 1, further including a tire cover mounting assembly carried by the tire carrier assembly, the tire cover assembly including a tire cover mounting sleeve.

7. The vehicle of claim 1, further including a vehicle accessory carried by the tire carrier assembly.

8. The vehicle of claim 7, further including a wiring harness connected between the vehicle accessory and the vehicle.

9. A vehicle, comprising:
a vehicle frame;
D-ring hinge and latch brackets coupled with the vehicle frame;
a tire carrier assembly carried by the D-ring hinge bracket; and
a tire cover assembly carried by the tire carrier support structure.

10. The vehicle of claim 9, wherein the tire carrier assembly is repeatably movable between raised and lowered positions.

11. The vehicle of claim 9, wherein the tire carrier assembly is repeatably movable between extended and retracted positions.

12. The vehicle of claim 10, wherein the tire cover assembly includes a tire cover support member movable between raised and lowered positions in response to moving the tire carrier support structure between raised and lowered positions.

13. The vehicle of claim 10, wherein the tire cover assembly includes a tire cover support member with an orientation adjustable in response to raising and lowering the tire carrier assembly.

14. The vehicle of claim 9, further including a tire cover mounting assembly carried by the tire carrier assembly, the tire cover assembly including a tire cover mounting arm which carries a tire cover mounting sleeve.

15. The vehicle of claim 9, further including a vehicle accessory carried by the tire cover assembly.

16. The vehicle of claim 15, further including a wiring harness connected between the vehicle accessory and an electrical system of the vehicle.

17. A vehicle, comprising:
a vehicle frame having opposed longitudinal frame members;
a tire carrier support structure coupled with the longitudinal frame members so it extends between them; and
D-ring hinge and latch brackets coupled with the vehicle frame through the tire carrier support structure.

18. The vehicle of claim 17, further including a vehicle bumper positioned between the tire carrier support structure and the d-ring hinge and latch assemblies.

19. The vehicle of claim 17, wherein the tire carrier support structure includes a trailer hitch which extends through the vehicle bumper.

20. The vehicle of claim 17, wherein the tire carrier support structure is slidingly engaged with the opposed longitudinal frame members.

21. The vehicle of claim 17, wherein the tire carrier support structure including opposed c-brackets sized and shaped to engage corresponding longitudinal frame members.

22. The vehicle of claim 17, further including a tire carrier assembly coupled with the d-ring hinge bracket.

23. The vehicle of claim 22, wherein the tire carrier assembly is repeatably movable between raised and lowered positions.

24. The vehicle of claim 22, further including a tire cover assembly coupled with the tire carrier assembly.

25. A vehicle, comprising:
a vehicle frame having opposing longitudinal frame members;
opposing frame extensions coupled with corresponding longitudinal frame members;
D-ring hinge and latch brackets coupled with corresponding frame extensions; and
a tire carrier assembly coupled with the D-ring hinge bracket.

26. The vehicle of claim 25, further including a vehicle bumper carried by the opposing frame extensions.

27. The vehicle of claim 25, wherein the tire carrier assembly is repeatable movable between raised and lowered positions.

28. The vehicle of claim 25, further including a tire cover assembly coupled with the tire carrier assembly.

29. The vehicle of claim 28, further including a vehicle accessory carried by the tire cover assembly.

30. The vehicle of claim 29, wherein the vehicle accessory is connected to the electrical system of the vehicle.
